(19) United States
(12) Patent Application Publication
(10) Pub. No.: US 2011/0276349 A1
(43) Pub. Date: Nov. 10, 2011

(54) Publishing Templates Having Practice Defined Triggers

(75) Inventors: Boan Huang, Quakertown, PA (US); Anthony M. DiMauro, Conshohocken, PA (US); Benjamin Dubinsky, Ivyland, PA (US)

(73) Assignee: NEXTGEN HEALTHCARE INFORMATION SYSTEMS. INC., Horsham, PA (US)

(21) Appl. No.: 13/104,372

(22) Filed: May 10, 2011

Related U.S. Application Data
(60) Provisional application No. 61/332,960, filed on May 10, 2010.

(51) Int. Cl. G06Q 50/00

(52) U.S. Cl. 705/3

(57) ABSTRACT

A healthcare management system is presented where the management system can include a data routing engine configured to route patient data to various authorized providers as a function of one or more trigger rules. The routing engine can operate as a web portal, through which clients of system can define medical form templates, where a template can include one or more triggering rules that cause further action to take place. When a patient interfaces to the web portal, the portal can render a medical form for the patient based on the template. As the patient interacts with the form, including entering their patient data, the routing engine can determine if any triggering criteria have been satisfied. If so, further actions can place including routing the data to authorized entities or providing notifications.

This application claims the benefit of priority to U.S. provisional application having Ser. No. 61/332,960 filed on May 10, 2010. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is distributed medical data technologies.

### BACKGROUND

Distribution of patient healthcare data to authorized individuals continues to be an issue throughout the healthcare industry. Many problems arise due to issues concerning patient confidentiality, proprietary technologies, conflicting standards, or other such conditions. Most healthcare providers elect to utilize third party applications or services to reduce the issues encountered with managing patient data. Unfortunately, known third party solutions fail to take into account that patient data is quite dynamic and can change in real-time, and that providers all have a preferred or proprietary technology for managing data. Although third party solutions provide some alleviation of the various problems, the third party solutions introduce additional problems. For example, providers often suffer from vendor lock-in where the provider must continue to pay extensive fees to keep a solution viable without having the ability to shift to other technologies.

Others have attempted to address the myriad of issues surrounding healthcare data management. For example, various aspects of managing healthcare data are discussed in the following references: U.S. patent publ. no. 2004/0172306 to Wohl et al.(publ. September 2004); U.S. patent publ. no. 2005/0027567 to Taha (publ. February 2005); U.S. patent publ. no. 2005/0027569 to Gollogy et al. (publ. February 2005); U.S. patent publ. no. 2008/0097952 to Eswaran (publ. April 2008); U.S. patent publ. no. 2008/0215369 to Lareau (publ. September 2008); and WIPO publ. no. 2006/056003 to Cohen (publ. June 2006).

Although the above references are suitable for their intended purposes, they all fail to appreciate various aspects of managing dynamic healthcare data, especially in a more patient-centric environment. It has yet to be appreciated that a patient data management system should provide infrastructure for handling dynamic patient data, where the data could change literally as the data is entered. For example, a preferred system would offer support to a healthcare provider for creating various forms that can be filled out by the patient. As the patient enters data, the form can dynamically change to reflect data entered, dynamically alter the flow of questioning, or even dynamically alter a layout of the form during use. Such dynamic capabilities can be achieved via supporting triggered events within dynamic forms. Furthermore, a system should map entered data to a provider's preferred data format or management solution.

Therefore, there remains a considerable need for methods, systems, and configurations to provide support for managing dynamic healthcare data obtained from patients.

### SUMMARY OF THE INVENTION

The inventive subject matter provides apparatus, systems and methods in which one can manage healthcare data, and obtain the healthcare data from a patient through the use of medical form templates define by a client healthcare provider. One aspect of the inventive subject matter includes a data routing engine, which can include a client template interface through which a client (e.g., healthcare provider, private practice, hospital, etc.) can define a medical form template. The template can have one or more data points (e.g., data entry fields) where patient data can be entered.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The data routing engine can also include a patient interface that is configured to generate an instance of the medical form template as a medical form. For example, the patient interface can include a web page generated and presented by the data routing engine, in which the web page is generated according to the medical form template. In such example, the web page could provide the patient with access to the data points. Thus, the patient interface can thereby allow a patient to have interactions with the medical form.

The medical form template can include one or more trigger rules, possibly defined by the client through a client trigger interface, where the trigger rules define conditions or criteria when further action can be taken with respect to the medical form or patient data. Preferably, the trigger rules are defined as a function of patient interactions with the medical form and the patient data points provided.

A data router can be configured to route the patient data points entered into the medical form by the patient among authorized providers according to the trigger rules. Such authorized providers could include, for example, healthcare providers, laboratories, the client, the patient, hospitals, and so forth. In some embodiments, the data routing engine can include a template library configured to store multiple templates that can be used or modified by one or more clients.

Another aspect of the inventive subject matter comprises a dynamic form system. The system can include a form definition interface (e.g., a client interface) which is configured to allow a user to define a dynamic form template based on form properties (e.g., data points, field names, template metadata, form metadata, times, dates, etc.) and on form triggers. A prefer dynamic form system can also include a template library for storing dynamic form templates including previously defined forms or newly created forms. A form rendering engine can present or otherwise render a form via a user interface (e.g., web page) according to the form's template as defined by the templates properties. As a user (e.g., a patient) interacts with the template-based form, the interactions can trigger an action where the form can be re-rendered by the form rendering engine according to one or more of the trigger rules included in the template.

Yet another aspect of the inventive subject matter is considered to include a patient notification system. A healthcare database can store patient data from many different patients, possibly patient data spread across multiple healthcare providers. The patient's data can be assigned one or more patient attributes associated with the patients. A user (e.g., healthcare provider) can utilize a notification interface to define a notification criteria (e.g., triggering rules) for sending notifications based on the patient attributes. In some embodiments, notifications can be sent to multiple patients having a shared or common attribute. The system can further comprise a notification router that identifies patients having attributes that satisfy the notification criteria. Upon satisfaction of the notification criteria, the notification router can send notifications (e.g., email, phone messages, letters, etc.) to the patients.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic of one embodiment of a healthcare data management system.

### DETAILED DESCRIPTION

It should be noted that while the following description is drawn to a computer/server based healthcare data management system, various alternative configurations are also deemed suitable and may employ various computing devices including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including routing of dynamic patient data among authorized healthcare providers without requiring each of the healthcare providers to interface with each other unnecessarily.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following discussion references various computing infrastructure. It should be appreciated that the interfaces, engines, routers, or other systems can be embodied by computing devices having a processor configured to execute software instructions stored on a computer readable medium, where the software instructions encode programmatic functionality directed toward the disclosed subject matter. In a preferred embodiment, the web portal comprises one or more web services configured to provide the contemplated functionalities as a web service. It should be appreciated the various devices can interact with each other over a packet switched network (e.g., the Internet), preferably through web enabled infrastructure (e.g., web servers, web browsers, web services APIs, etc.).

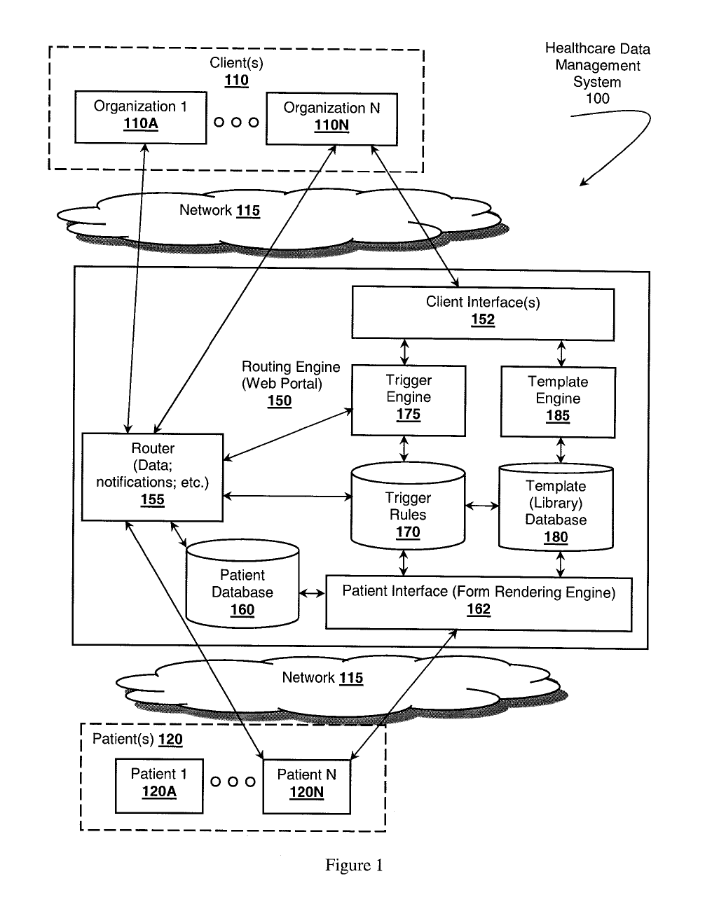

FIG. 1 presents a schematic of one embodiment of a healthcare data management system 100 that is capable of interfacing with patients 120 (e.g., patient 120A through 120N) as well as healthcare providers (e.g., clients 110) and other who subscribe to the management system 100. Client 110 can include one or more of clients 110A through 110N.

In one aspect of the inventive subject matter, the healthcare data management system 100 can include a data routing engine 150. In some contemplated embodiments, the data routing engine 150 can be operated as a web portal capable of supplying patient data management infrastructure to its clients 110 and providing interfaces to patients 120, through which patients 120A through 120N can enter their own data. The data routing engine 150 can provide a client interface 152 through which client 110 can define a medical form template. The definition of the medical form template can stem from an existing template, possibly stored in a template library 180, or can be a newly defined template. The medical form template can comprise one or more data points (e.g., data entry fields) that can be used to capture data from a patient 120, or possibly other sources. The medical form template can be represented as serialized computer-readable instructions (e.g., XML or its variants), which can be used to render an actual medical form when desired over network 115. The rendering of the medical form can be presented to patient 120, who can then enter data into the medical form.

It is contemplated that template library 180 could store thousands of template definitions, or more. In some embodiments, the template definitions can include medical form templates that are initially created by the healthcare data management system 100 to cover common tasks or common data format conversion issues. The initial medical form templates can be modified to fit the needs of the client 110 (e.g., changing data points, changing data field tags, changing layouts, changing branding, etc.). The template library 180 can also store proprietary templates available only to authorized client 110 (e.g., a person, a practice, a hospital, etc). It is also contemplated that the medical form templates can be shared among clients 110, patients 120, or others engaged using data routing engine 150, assuming that proper authentication or authorization has been granted.

The data routing engine 150 could also include a form definition interface, such as a web page or other interface, through which a dynamic form template can be defined by a plurality of form properties and the plurality of trigger rules 170. It is contemplated that the dynamic form template could be stored in the template library 180. A template engine 185 could be provided that is configured to (a) render a medical form on the patient interface 162 according to the form properties read from the template library 180, and (b) to re-render the medical form on the patient interface 162 in real-time upon actuation of at least one trigger rule from the plurality of trigger rules 170. The template engine 185 could be interconnected with the patient interface 162 using network 115, which could be a packet switched network (e.g., a web page over the Internet). In some contemplated embodiments, the template engine 185 can be further configured to alter a logical flow or a layout of the medical form upon actuation of the at least one trigger rule 170.

The medical form templates in template library 180 can also include basic trigger rules 170, which outline possible actions that can take place depending upon interaction by patients 120 with instances of the medical form templates. Client 110 can modify one or more of the trigger rules 170 for the actions to fit a particular patient 120A or group of patients 120. One should also appreciate that the medical form templates can be used as a foundation for creating other medical form templates where the trigger rules 170 could be inherited from one medical form template to another. For example, a basic template for addresses could be used to create a basic patient in-take form template, which in turn can be used to create a medical history form template and so on, where rules can be inherited at each level.

In a preferred embodiment, a client 110 is able to update their medical form template at any time, which can trigger an update to any corresponding medical forms generated therefrom. The updates introduced by the client 110 can trigger the updates to be rendered in a displayed medical form that is currently in use by a patient 120, preferably, although not necessarily, in real-time. Such an approach provides several benefits. One benefit is that a web service as offered by data routing engine 150 storing various templates no longer requires completely defined, static forms (e.g., static web pages, PDF files, etc.) before presenting the medical forms to a patient 120, which are difficult to maintain or update. Rather, the web service allows for dynamic updates to medical form templates without requiring submission of new medical forms. This is especially useful when many clients 110 have different or proprietary medical forms. Another benefit includes ensuring that the patient 120 always has access to the most recent, current version of a medical form.

As used herein, the term “client” preferably represents a healthcare provider or other organization within the healthcare industry that subscribes to, or is otherwise authorized to use the services of data routing engine 150. Clients 110 can include, for example, a doctor's practice, an individual healthcare provider, an insurance company, a pharmacy, or other healthcare organization. Clients 110 generally have a proprietary technology or data format for managing their patient data. One should note that individual persons (e.g., a nurse, a doctor, etc.) can also be a client 110 of the data routing engine 150.

As used herein, the term “patient” preferably represents an individual recipient of healthcare products or services supplied by one or more clients 110 of the data routing engine 150. Preferably patients 120 interface to the data routing engine 150 through patient interface 162 (e.g., web page) to view or to enter their patient data that can then be accessed by, or sent to, clients 110. Clients 110 and patients 120 can interact with data routing engine 150 over network 115 (e.g., Internet, WAN, etc.).

For example, where a patient in-take form template has been defined by the service offering data routing engine 150, each of clients 110 would likely require a patient in-take form and could use the in-take form template as a foundation for their own in-take form. However, client 110A could very well require slightly different information or would prefer to have the data in a different format than client 110N. Therefore, client 110A would define different properties for their version of the medical form than those from client 110N. It is true that each version of the medical form would likely still have patient names, addresses, and phone numbers (e.g., the same properties), the versions might require different information regarding other attributes of the patients 120 (e.g., medical history, family history, etc.).

The data routing engine 150 can also include a patient interface 162, which is capable of converting the serialized or other formats of instructions from the medical form template into a rendered medical form, and then presenting the medical form to a patient 120, preferably over network 115 that could be a packet switched network (e.g., a web page over the Internet). Various manners of generating instances of a template are known in the art and could be used including, for example, those described in U.S. patent publ. no. 2010/0138239 to Reicher, et al. (publ. June 2010). Through the patient interface 162, the patient 120 can have interactions with the medical form.

A preferred medical form stems from a medical form template defined in terms of properties, and trigger rules 170. Example properties can include various metadata, attributes, tags, data fields, data points, or other information that can be used to describe a form. Trigger rules 170 represent various rules or other criteria that depend on interactions with a patient 120 with respect to various properties of the form. For example, the trigger rules 170 can depend on data entered, selections of options, actions taken by the patient 120, geo-location of patient 120, or other types of interactions.

Preferably the management system 100 is data format agnostic by providing one or more data format conversion modules (not shown) that can convert patient data from a first data format to a data format that meets the requirements of a client 110. In such an embodiment, the data routing engine 150 can offer data format conversion services, possibly as an intermediary, to its various clients 110 where the patient data is converted from a format of a first client 110A to a format of a second client 110N.

Preferably routing engine 150 also offers support for defining, creating, or otherwise managing triggered events, preferably through trigger engine 175. Clients 110 can use client interface 152 (e.g., a web page, API, etc.) to interact with trigger engine 175 to define desirable trigger rules 170. Using the client trigger interface 152, the clients 110 can define a plurality of trigger rules 170 based upon patient data points and interactions by a patient 120 with the medical form. The trigger rules 170 can include triggering criteria that depends on interactions with patients 120, clients 110, patient data exchanged among the various parties, or properties of medical form templates used by clients 110 or patients 120. Example interactions can include, for example, entering data into a data point, selecting optional values for a data point, selecting additional information, requesting additional information, or even conducting research (e.g., search queries, view specific content, etc). Interactions could also include non-data submission activities including, for example, specific positioning, hovering, or other actions of a patient's mouse pointer, scrolling through the medical form, evidence of frustration by the patient, and so forth.

For example, trigger rules 170 could be used to detect confusion or frustration by a patient through the patient's interaction with the medical form. For example, if the patient requests additional information about various prompts or questions, the medical form could be dynamically amended to include additional explanation for each of the requested data points on the medical form. In addition, one or more of the trigger rules 170 could detect that a patient's mouse pointer is hovering at a certain point of the medical form for longer than a defined period of time. When such interaction with the medical form is detected, a window or embedded explanation could be overlaid or dynamically added to the medical form while the form is in use.

Trigger rules 170 can be used in various ways to facilitate management or acquisition of patient data as discussed herein. When the criteria within trigger rules 170 have been satisfied, routing engine 150 can take additional actions as defined by trigger rules 170. The plurality of trigger rules 170 can also be based upon various parameters including, for example, attribute-value pairs associated with the patient 120, actions taken by the patient 120, time or date information, metadata associated with the medical form template, interactions with the patient 120, and other information encoded with the template.

In preferred embodiments, trigger rules 170 can also be used to determine if or when data points of the form can be automatically filled out (e.g., pre-populated) for the patient 120. For example, each patient data point could be configured with an appropriate set of trigger criteria that can depend on various medical form properties including entered data. As the patient 120 enters data into the medical form, a trigger might be actuated to fill in other fields. A patient 120 might enter a place of employment, and a trigger could actuate causing group insurance policy information corresponding with the place of employment to be automatically inserted into the form, for example.

The data routing engine 150, operating as a web portal, also preferably provides a data router 155 capable of accepting patient data points entered by the patient 120. The data router 155 can consult the trigger rules 170 or other template rules to determine what further actions, if any, should be taken. For example, the data router 155 can determine the patient data points should be routed based on trigger rules 170. It is contemplated that data can be routed in real-time as data is entered into a medical form, although the data could also be routed after data-entry is completed. The patient data points can be routed to patient database 160, patient 120, client 110A, client 110N, or to other authorized providers. Naturally, such routing can also include authenticating or authorizing each recipient as a valid receiver of the patient data points.

It is contemplated that each recipient could receive, but not necessarily view, the patient data points entered into the medical form. In some contemplated embodiments, one authorized client 110A may have a different level of access to the medical form than another authorized client 110N. For example, a hospital's clerical staff may be able to view patient identifiers such as name, patient identification number, date of birth, and so forth, so that the medical form can properly routed or stored, but not be able to view the remainder of the medical form.

Example web portals that can be adapted for use within the inventive subject matter includes NextGen® Patient Portal, NextGen® Practice Management, or NextGen^{SM} Health Information Exchange (see URL www.nextgen.com).

As a patient 120 interacts with a medical form, routing engine 150 can monitor changes made by the patient 120 to determine if any triggering conditions have been met, possibly through trigger engine 175. When a trigger condition has been met, the rendering engine (e.g., patient interface 162) can re-render the medical form according to the trigger rules 170 as defined for that medical form. In a preferred embodiment, the rendering engine can alter the flow of questioning presented to the patient 120, alter a layout of the medical form, or change other aspects of a rendered medical form, even in real-time in response to one or more of the trigger rules 170. Such an approach offers patients 120 an ability to conduct web-based research from within the medical form itself for information pertaining to various form data points. For example, a medical form might request information for a specific condition with which the patient 120 is unfamiliar. Patient interface 162 can interact with the template engine 185 to trigger an alteration of the medical form according to trigger rules 170 to provide a search interface through which the patient 120 can obtain further information about a specific condition.

One should appreciate several issues associated with routing patient data points according to trigger rules 170. First, the patient data points can be stored in a patient database 160. The trigger rules 170 can operate as a function of historical patient data stored in patient database 160 in addition to operating as a function of the entered patient data points or interactions with a patient 120. Second, the trigger rules 170 can be triggered by conditions that depend upon multiple patients 120A-120N in addition to being triggered by conditions that solely depend upon the patient 120 interacting with the current medical form. Third, the trigger rules 170 can route patient data to any of the clients 110. For example, client 110A can create a medical form template having trigger rules 170 that trigger upon past infections. When one or more of the trigger rules 170 is engaged, the infection information, assuming proper authentication, can be routed to client 110N, possibly representing a lab or researcher, for example. One should note that although client 110A defined the trigger rules 170 relating to the medical form template, the data routed does not necessarily have to be routed exclusively to client 110A but can also be routed to other non-affiliated clients 110 (e.g., clients that are independent entities with respect to client 110A). Indeed, one type of action that can be triggered by trigger rules 170 includes routing patient data from one of client 110 to another. For example, as patient 120N interacts with a template-base form, data router 155 can route the data to an appropriate location: patient database 160, client 110A, client 110N, or other entity.

As another example, consider patient 120N that is currently taking a prescription and is about to see a primary healthcare provider (e.g., client 110A). As patient 120N enters data into an appointment form for the provider, patient 120N can also enter prescription information. The data router 155 determines from trigger rules 170 that the prescription information should be routed to the patient's primary provider as well as a local pharmacy (e.g., client 110N). In either case, preferably the data can be automatically converted to each client's preferred data format.

It is contemplated that the client interfaces 152 including the client template interface and the client trigger interface, the patient interface 162, and the data routing engine 150 can be interconnected by network 115.

In a preferred embodiment, data routing engine 150 operates as a for-fee service for clients 110, through which clients 110 can create medical form templates. Once a medical form template has been created, patients 120 can interact with a medical form rendered according to the template. As patients 120 enter data within the rendered medical form, one or more trigger rules 170 can be engaged causing further actions to be taken by routing engine 150. For example, as data is entered, routing rules can be triggered causing the data can be routed to one or more of clients 110 according to routing criteria defined in the medical form template. One should appreciate that trigger rules 170 are considered to include required conditions for an event to be triggered and an action to be taken when the conditions are satisfied.

One should also appreciate that the disclosed infrastructure provides for data routing engine 150 to operate as a patient-centric notification system where notifications are triggered based on interacting with data routing engine 150. As patients 120 enter their data into the dynamic medical forms, the patients' data can be stored in a patient database 160 and organized according to various patient attributes associated with patients 120. Patients 120 having common attributes, either raw attributes or normalized attributes, can also be logically grouped together. Contemplated patient attributes can include, for example, patient data including a medical history and family history, patient metadata, provider data, provider metadata, one or more prescriptions, and other data associated with the patient. Example patient attributes include, for example, medical history, family history, prescription information, geo-location, maladies, clinical data, time when patient last logged into the system, primary healthcare provider, or other attributes.

Preferably, routing engine 150 is further configured to provide a notification interface, possibly presented via the client interface 152, through which a client 110 of the portal can define one or more notifications as part of trigger rules 170. Alternatively, a separate notification router could be used. The criteria for determining if a patient 120, or other user, should receive a notification can be based on available information within the patient database 160 including patient attributes. Once a client 110 enters an appropriate message for the notification, the notification can be sent to all patients having attributes that match the criteria of the notification. It should be noted that the notification can be sent manually, or can be sent automatically in response to trigger rules 170.

In a situation where a prescription drug has been recalled, for example, a primary healthcare provider can log on to the web portal as a client 110 to create a notification. The notification interface can provide a notification form constructed based upon a notification template in a similar fashion as with medical forms. The healthcare provider can select all patients of the healthcare provider (a first attribute) that are prescribed the drug (a second attribute), where the attributes contribute to a definition of a trigger rules 170. The healthcare provider can then enter a message relating to the recall. Once satisfied with the notification, the healthcare provider can submit the notification manually to the web portal, which then distributes the message to all patients matching the attributes, or the notification could be sent automatically when a trigger is actuated by trigger engine 175, router 155, or even patient interface 162. It is also contemplated that the message could include portions of a dynamic medical form, possibly an appointment form including at least some automatically filled-in data. Additionally, the notification could be sent to a patient's pharmacy, another client 110 of system 100, to notify the pharmacy that the patient 120 requires a new prescription.

A notification can be sent via one or more communication methods. Contemplated methods of sending a notification include email, phone call, traditional letter, a Twitter™ or other social networking message, text message, phone voice mail, or other known or yet to be invented communication system.

The use of trigger rules 170 and medical form templates provide many additional beneficial uses. For example, the trigger rules 170 can be used for launching browser dialogs that allow a patient 120 to search for pieces of information outside the context of a medical form template including allowing a patient to select or change a preferred pharmacy, browse for specific medication from a listing, and browse for particular healthcare provider. In addition, the trigger rules 170 can be used to allow a template designer to include data entry validation logic. The trigger rules 170 can also be used to allow the patient to invoke functionality native to the web portal, sending messages or setting appointments, for example, and to support patient education by triggering the display of rich media, audio, or video information from within a medical form template.

In some contemplated embodiments, the trigger rules 170 can be used to generate tasks, alerts, or other client-centric (e.g., a healthcare provider's practice) functionality. Should a data point's data, properties, or other attributes fall outside required parameters, a preferred web portal can create tasks or alerts which can be assigned to the client 110 as function of the required parameters. It is also contemplated that the trigger rules 170 can be used for client-centric notifications. For example, as a patient enters data into a dynamic form, the web portal can send a notification to the client based on pre-defined trigger rules. One should also appreciate that a trigger notification could also be sent when information is not entered by a patient. Such an approach allows a client to document an interaction with the patient that would ordinarily not be documented unless managed by a third party, possibly by a courier or certified mail.

In other embodiments, the trigger rules 170 can be used to call internal or external functionality. For example, as a patient 120 or client 110 interacts with a preferred web portal, one or more of the trigger rules 170 can cause a medical form or medical form template to access medication search capabilities, drug interaction research facilities, directions, pharmacy locations. The trigger rules 170 can also be used to access objects or equipment internal to a practice including printers, scanners, lab equipment, or other devices. In further contemplated embodiments, the trigger rules 170 can be used to allow a template designer to include data entry validation logic, or allow for importing or querying for data from an outside source via a web service, REST, JSON, or other provider. The data can then be presented to a patient 120.

The trigger rules 170 can also be built based on attributes of a client 110 (e.g., public or private attributes), payer regulations or requirements, governmental regulations or requirements, or non-regulatory requirements.

Although the disclosed embodiment is described within the concept of a medical data service provider, the disclosed techniques can be adapted to other types of data providers. Other types of data providers can include those that provide web content (e.g., blogs, news, forums, etc.), games, marketing leads, audio programming, video programming, or other types of data.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A data routing engine, comprising:
a client template interface through which a client is enabled to define a medical form template having patient data points;
a patient interface configured to render the medical form template as a medical form, and through which a patient is enabled to have interactions with the medical form;
a client trigger interface through which the client is enabled to define a plurality of trigger rules as a function of the interactions and the patient data points; and
a data router configured to route the patient data points entered into the medical form via the patient interface among authorized providers as a function of the trigger rules.

2. The data routing engine of claim 1, further comprising a network interconnecting the client template interface, the patient interface, the client trigger interface, and the data router.

3. The data routing engine of claim 1, wherein the client template interface further comprises a medical form template library.

4. The data routing engine of claim 1, wherein the client trigger interface enables the client to define the plurality of trigger rules based upon metadata associated with the medical form template.

5. The data routing engine of claim 1, wherein the authorized providers includes at least one of the client and the patient.

6. The data routing engine of claim 1, wherein the interactions include at least one of entering data into a data point and selecting an optional choice for a data point.

7. The data routing engine of claim 1, further comprising:
a form definition interface through which a dynamic form template is defined by a plurality of form properties and the plurality of trigger rules;
a template library configured to store the dynamic form template on a storage device; and
a form rendering engine configured (a) to render a medical form on the patient interface according to the form properties read from the template library, and (b) to re-render the medical form on the patient interface in real-time upon actuation of at least one trigger rule from the plurality of trigger rules.

8. The data routing engine of claim 7, wherein the form definition interface comprises a web interface.

9. The data routing engine of claim 7, further comprising a packet switched network that interconnects the patient interface and the form rendering engine.

10. The data routing engine of claim 7, wherein the form rendering engine is further configured to alter a logical flow of the medical form upon actuation of the at least one trigger rule.

11. The data routing engine of claim 7, wherein the form rendering engine is further configured to alter a layout of the medical form upon actuation of the at least one trigger rule.

12. The data routing engine of claim 1, further comprising:
a patient database storing patient data points from a plurality of unaffiliated patients, where the patient data points includes patient attributes associated with each of the unaffiliated patients;
a notification interface through which at least one of the client and the authorized providers is enabled to define notification criteria based the patient attributes; and
wherein the data router is further configured to (a) identify a set of patients from the plurality of unaffiliated patients that satisfies the notification criteria, and (b) send a notification to the set of patients.

13. The data routing engine of claim 12, wherein the patient attributes comprise at least one of a medical history, a family history, and a prescription.

14. The data routing engine of claim 12, wherein the data router is further configured to send the notification via email.

15. The data routing engine of claim 12, wherein the data router is further configured to send the notification via at least one of a phone message, a letter, and a social networking message.

16. The data routing engine of claim 12, wherein the set of patients have at least one patient attribute in common.

17. The data routing engine of claim 1, further comprising a medical form template library configured to store the medical form template as serialized instructions.

18. The data routing engine of claim 17, wherein the medical form template library is further configured to store the medical form template via a form of XML.

19. The data routing engine of claim 1, wherein the client interacts with at least one of the client template interface and the client trigger interface over a packet switched network.

20. The data routing engine of claim 1, wherein the patient interacts with the patient interface over a packet switched network.
